(19) United States
(12) Patent Application Publication
(10) Pub. No.: US 2009/0303148 A1
(43) Pub. Date: Dec. 10, 2009

(54) ANTENNA DEVICE FOR SHIFTING RESONANCE FREQUENCY

(75) Inventors: Yeung Jun CHO, Anyang-si (KR); Yong Jin KIM, Seoul (KR); Byung Man LIM, Seoul (KR); Jae Ho LEE, Yongin-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/478,383

(22) Filed: Jun. 4, 2009

(30) Foreign Application Priority Data
Jun. 4, 2008 (KR) 10-2008-0052571

(51) Int. Cl. H01Q 1/00

(52) U.S. Cl. 343/787

(57) ABSTRACT

An antenna device for shifting a resonance frequency including an antenna pattern having a first resonance frequency and a magnetic body disposed within a predetermined distance of or contacting with one side of the antenna pattern for shifting the first resonance frequency to a second resonance frequency. When the first resonance frequency of the antenna pattern is shifted to the second resonance frequency, radiation efficiency is not reduced.

### PRIORITY

This application claims priority to and the benefit of Korean Patent Application No. 10-2008-0052571, which was filed in the Korean Intellectual Property Office on Jun. 4, 2008, the entire contents of which are incorporated herein by reference.

### BACKGROUND OF THE INVENTION

1. Field of the Invention

The present invention relates generally to an antenna device for a mobile terminal, and more particularly, to an antenna device including a magnetic body added to an antenna pattern in order to shift a first resonance frequency of an antenna pattern to a second resonance frequency.

2. Description of the Related Art

The trend with electronic devices, especially mobile terminals, is for the newer devices to provide the same, if not more, functionality in a smaller device. In order to satisfy such demands, internal circuits and parts of mobile terminals are decreasing in size.

Commonly, an antenna of a mobile terminal is mounted within the mobile terminal, and is often referred to as an “intenna”. The antenna is designed to have a resonance frequency in a transmission and reception frequency band of a signal in order to efficiently transmit and receive signals.

Mobile communication providers provide mobile communication services using a predetermined frequency band allocated thereto. Accordingly, mobile terminal manufacturers provide different antennas for the different frequency bands provided by the mobile communication providers. Therefore, in order for a mobile terminal that provides a communication service in a high frequency band to also provide a communication service in a low frequency band, the mobile terminal requires an additional mounting space for additional antenna length to also handle the low frequency band, and thus a change in the design of the mobile terminal is necessary. This increases costs to a mobile terminal manufacturer due to design changes and redevelopment of the antenna and also results in a corresponding increase in purchase price of the mobile terminal for a consumer. Such a problem may theoretically be solved using a broadband antenna that can cover all frequency bands of a communication service provided by the mobile communication providers, however it is impossible to utilize a broadband antenna in a mobile terminal of a small size.

### SUMMARY OF THE INVENTION

The present invention has been designed in view of the above and other problems occurring in the prior art, and provides an antenna device for shifting a resonance frequency of an antenna without changing an antenna pattern or reducing radiation performance.

In accordance with an aspect of the present invention, an antenna device for shifting a resonance frequency includes an antenna pattern having a first resonance frequency; and a magnetic body disposed within a predetermined distance of or contacting with one side of the antenna pattern for shifting the first resonance frequency to a second resonance frequency.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1A is a perspective view of an antenna device according to an embodiment of the present invention, and FIG. 1B is a sectional view of the antenna device taken along line A-A′ of FIG. 1A;

FIG. 2A is a perspective view of an antenna device according to another embodiment of the present invention, and FIG. 2B is a sectional view of the antenna device taken along line B-B′ of FIG. 2A;

FIG. 3A is a perspective view of an antenna device according to another embodiment of the present invention, and FIG. 3B is a sectional view of the antenna device taken along line C-C′ of FIG. 3A;

FIG. 4A is a perspective view of an antenna device according to another embodiment of the present invention, and FIG. 4B is a sectional view of the antenna device taken along line D-D′ of FIG. 4A;

FIGS. 5A and 5B are graphs illustrating a shift of a resonance frequency of the antenna device of FIG. 3A; and

FIGS. 6A and 6B are graphs illustrating radiation efficiency of the antenna device of FIG. 3A.

### DETAILED DESCRIPTION OF EMBODIMENTS OF THE PRESENT INVENTION

Hereinafter, embodiments of the present invention are described in detail with reference to the accompanying drawings. The same reference numbers are used throughout the drawings to refer to the same or like parts. The views in the drawings are schematic views only, and are not intended to be to scale or correctly proportioned.

Detailed descriptions of well-known functions and structures incorporated is herein may be omitted to avoid obscuring the subject matter of the present invention.

In the following description, for convenience of description, a mobile terminal including an antenna device is embodied as a mobile communication terminal, although the mobile terminal is not limited thereto. That is, the mobile terminal including an antenna device may be any of a mobile communication terminal, a mobile phone, a Personal Digital Assistant (PDA), a smart phone, an International Mobile Telecommunication 2000 (IMT-2000) terminal, a Code Division Multiple Access (CDMA) terminal, a Global System for Mobile Communication (GSM) terminal, and a Universal Mobile Telecommunication Service (UMTS) terminal.

When a magnetic body contacts with or is disposed adjacent to an antenna pattern, a shift principle of a resonance frequency of the antenna pattern can be represented as shown by Equation 1.

More specifically, the Length (L) of a general λ/4 dipole antenna is obtained by Equation 1.

$$L = \frac{λ}{4} = \frac{C}{4 f \sqrt{{ɛ}_{γ} \cdot {μ}_{γ}}} \qquad ( 1 )$$

In Equation 1, λ is a wavelength, C is the speed of light, f is a resonance frequency, ε_{γ} is a dielectric constant, and μ_{γ} is magnetic permeability. Equation 1 can also be represented as shown by Equation 2 of a resonance frequency f.

$$f = \frac{C}{λ \sqrt{{ɛ}_{γ} \cdot {μ}_{γ}}} \qquad ( 2 )$$

In Equation 2, if it is assumed that C and λ are constants, the resonance frequency f of the antenna pattern is inversely proportional to the square root of multiplication of a dielectric constant and magnetic permeability. That is, Equation 2 shows that a resonance frequency can be changed according to a dielectric constant and magnetic permeability in the same antenna pattern.

In accordance with an embodiment of the present invention, a resonance frequency of the antenna pattern is shifted by contacting a magnetic body having high magnetic permeability with the antenna pattern or by disposing the magnetic body having high magnetic permeability adjacent to, i.e., within a predetermined distance of, the antenna pattern. Referring to Equation 2, by contacting a material having a large dielectric constant with the antenna pattern or by disposing a material having a large dielectric constant adjacent to the antenna pattern, a resonance frequency can be shifted. However, a large dielectric constant also reduces radiation efficiency of the antenna pattern. By using a magnetic body having a high magnetic permeability (for example, ferrite), radiation efficiency of the antenna pattern can be constantly sustained. A detailed description of such radiation efficiency will be described below.

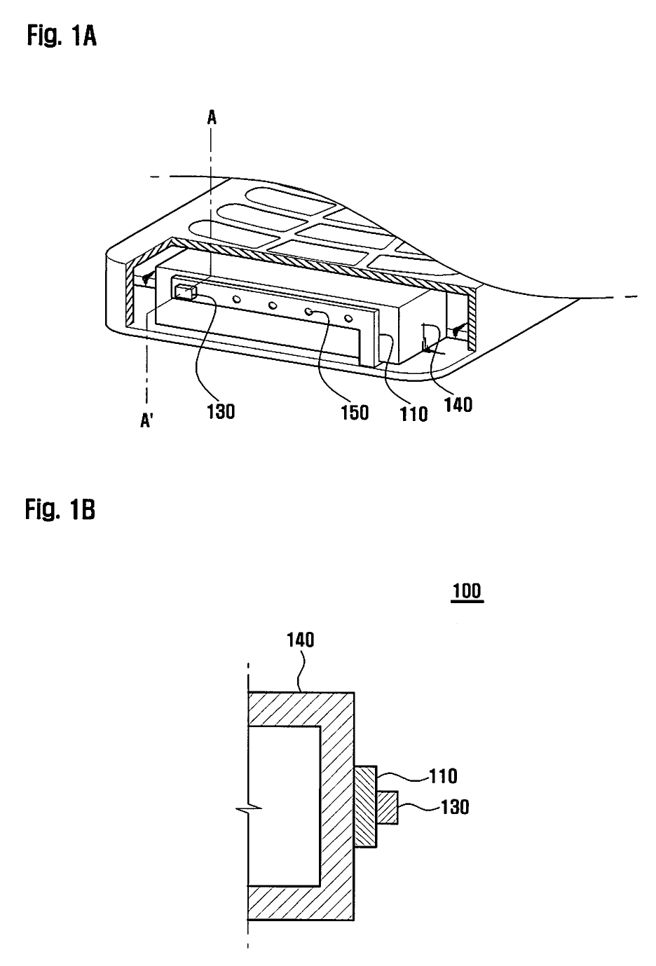

FIG. 1A is a perspective view of an antenna device according to an embodiment of the present invention, and FIG. 1B is a sectional view of the antenna device taken along line A-A′ of FIG. 1A.

Referring to FIGS. 1A and 1B, an antenna device 100 according to the present embodiment includes an antenna pattern 110 designed to have a first resonance frequency, a magnetic body 130 for shifting a resonance frequency (the first resonance frequency) of the antenna pattern 110, and a carrier 140 for mounting the antenna pattern 110.

The carrier 140 is formed in a rectangular form on which the antenna pattern 110 is mounted at one side surface thereof, and is mounted within a mobile terminal. In order to fix the antenna pattern 110, the carrier 140 includes one or more protrusions 150 at one side surface thereof. The carrier 140 further includes a component for fixing the carrier 140 within the mobile terminal. A form of the carrier 140 is not limited to the rectangular form shown in FIGS. 1A and 1B, as the carrier 140 can have various forms according to forms of the mobile terminal.

Further, in FIGS. 1A and 1B, the carrier 140 is positioned at a lower part (generally, near a microphone) of the mobile terminal; however, a location of the carrier 140 is not limited thereto. That is, the carrier 140 may also be positioned at an upper part or on a side surface of the mobile terminal.

The antenna pattern 110 includes a rectangular metal plate (for example, a copper plate) having a predetermined thickness, and a feeding unit (not shown) for connecting the antenna pattern 110 and a Printed Circuit Board (PCB). The antenna pattern 110 has the first resonance frequency for efficiently transmitting and receiving a signal in a frequency band allocated to a specific mobile communication provider. The antenna pattern 110 is attached to one side surface of the carrier 140. For example, the antenna pattern 110 is attached to a surface on which the protrusion 150 of the carrier 140 is formed and is fixed by the protrusion 150. In this case, the antenna pattern 110 has a hole into which the protrusion 150 is forcibly fitted.

When the magnetic body 130 contacts with or is disposed adjacent to the antenna pattern 110, a first resonance frequency of the antenna pattern 110 can be shifted to another resonance frequency (a second resonance frequency). That is, according to the present invention, a mobile terminal having the same specification can use the same antenna pattern without having to redesign the antenna pattern according to a frequency band provided by another mobile communication provider when using a communication service.

The feeding unit is positioned at an end portion of one side of the antenna pattern 110 and electrically connects the PCB and the antenna pattern 110.

In FIG. 1A, the antenna pattern 110 is formed in a rectangular form, however the form of the antenna pattern 110 is not limited thereto, as the antenna pattern 110 can have various forms according to a resonance frequency, a design of the mobile terminal, and/or radiation performance. Further, a location of the antenna pattern 110 attached to the carrier 140 is not limited to that illustrated in FIG. 1A, as the antenna pattern 110 can be attached to a selected specific surface of the carrier 140 according to a designer's intention.

The magnetic body 130 includes a magnetic material, wherein the material is one of ferromagnetic, ferrimagnetic, diamagnetic, and paramagnetic materials according to a magnetization degree and property.

In Accordance with an embodiment of the present invention, it is preferable that the magnetic body 130 uses one of ferromagnetic and ferrimagnetic materials having high magnetic permeability. For example, the magnetic body 130 according to the present embodiment may be made of ferrite.

It is preferable that the magnetic body 130 is formed in a rectangular form having a low height and having a width less than that of the antenna pattern 110 in consideration of a structure of a mobile terminal having a small thickness, and the magnetic body 130 contacts with or is disposed adjacent to one side of the antenna pattern 110. More specifically, when transmitting and receiving a signal, the magnetic body 130 contacts with or is disposed adjacent to a portion of the antenna pattern 110 having the highest current density, for example, at an end portion of the antenna pattern 110, as illustrated in FIG. 1A. Particularly, the magnetic body 130 according to the present embodiment is attached to an outer surface of the antenna pattern 110, i.e. a surface opposite to a surface contacting with the carrier 140. For example, the magnetic body 130 may be attached to the antenna pattern 110 with a double-sided adhesive tape.

Further, the magnetic body 130 is mounted at one side of a case of the mobile terminal, and when assembling the mobile terminal, the magnetic body 130 is fixed to the mobile terminal and is disposed adjacent to or in contact with the antenna pattern 110. Preferably, the mobile terminal case includes a groove for mounting the magnetic body 130. It is preferable that the groove is formed at a location having the highest current density of the antenna pattern 110 when transmitting and receiving a signal, for example, at a location corresponding to an end portion of the antenna pattern 110.

As indicated above, the form of the magnetic body 130 is not limited to that illustrated in FIG. 1A, as the magnetic body 130 can have various forms according to a design of the carrier 140. Further, magnetic permeability of the magnetic body 130 may be a value optimized through experimentation by a designer of the mobile terminal or of the antenna device according to a second resonance frequency to be shifted to. For example, when manufacturing the magnetic body 130 to have magnetic permeability corresponding to the difference between the first resonance frequency and the second resonance frequency to be shifted to, the designer can variably adjust a manufacturing environment such as a temperature and a pressure.

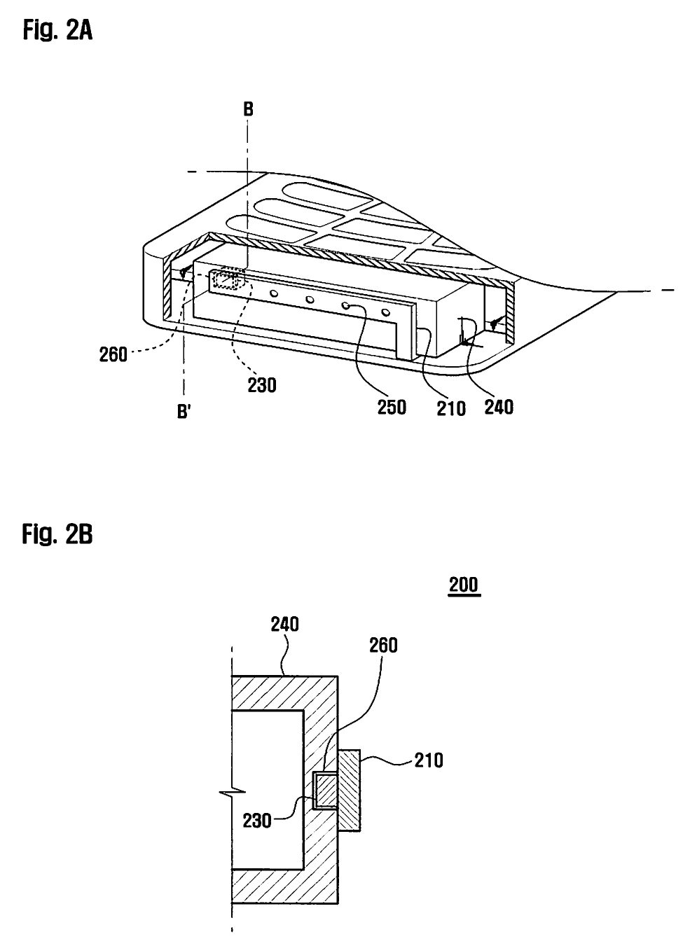

FIG. 2A is a perspective view of an antenna device according to another embodiment of the present invention, and FIG. 2B is a sectional view of the antenna device taken along line B-B′ of FIG. 2A.

Referring to FIGS. 2A and 2B, an antenna device 200 according to the present embodiment includes an antenna pattern 210 designed to have a first resonance frequency, a magnetic body 230 for shifting the first resonance frequency to a second resonance frequency, and a carrier 240 for mounting the antenna pattern 210.

The carrier 240 is formed in a rectangular form on which the antenna pattern 210 is mounted, and is mounted within a mobile terminal. The carrier 240 includes one or more protrusions 250 for fixing the antenna pattern 210 at one side surface thereof. The carrier 240 further includes a device for fixing the carrier 240 within the mobile terminal. Preferably, the carrier 240 according to the present embodiment includes at least one groove 260 for mounting the magnetic body 230. The groove 260 is formed at a location corresponding to a location at which the antenna pattern 210 is attached to the carrier 240. In this case, it is preferable that the groove 260 is formed at a location corresponding to an end portion of the antenna pattern 210 having the highest current density when transmitting and receiving a signal, as illustrated in FIG. 2A. Further, it is preferable that the groove 260 is formed at a depth such that the magnetic body 230 protrudes from a surface of the carrier 240 rather than being recessed below the surface of the carrier 240. The groove 260 may be formed as a hole according to a form of the carrier 240. However, the groove 260 according to the present embodiment is not limited to the rectangular form illustrated in FIGS. 2A and 2B, as the groove 260 can have various forms according to a form of the magnetic body 230.

The magnetic body 230 is inserted into the groove 260 to be disposed adjacent to, i.e., within a predetermined distance from, or contacting with the antenna pattern 210. In this case, it is preferable that the magnetic body 230 has a height greater than the depth of the groove 260 so as to easily contact with the antenna pattern 210.

When the groove 260 is formed as a hole, the magnetic body 230 is forcibly fitted into the hole so as to be disposed adjacent to or in contact with the antenna pattern 210. A form of the magnetic body 230 is not limited to the form shown in the present embodiment, and the magnetic body 230 can have various forms according to a design of the carrier 240. Further, magnetic permeability of the magnetic body 230 may be a value optimized through experimentation performed by a designer of the mobile terminal or of the antenna according to a second resonance frequency to be shifted to.

The antenna pattern 210 includes a rectangular metal plate (for example, a copper plate) having a predetermined thickness, and a feeding unit (not shown) for connecting the antenna pattern 210 and the PCB. Further, the antenna pattern 210 may have at least one hole into which a protrusion 250 formed in the carrier 240 is forcibly fitted. The antenna pattern 210 is mounted at one side surface of the carrier 240 such that one side of the antenna pattern 210 contacts with the magnetic body 230 inserted into the groove 260, and is fixed by the protrusion 250 formed in the carrier 240. The feeding unit is positioned at an end portion of one side of the antenna pattern 210 and electrically connects the PCB and the antenna pattern 210.

A form of the antenna pattern 210 and a location of the antenna pattern 210 attached to the carrier 240 are not limited to those illustrated in FIGS. 2A and 2B.

Hereinafter, an antenna device according to an embodiment of the present invention is applied to a multiple band antenna device using a plurality of antenna patterns. For convenience of description, however, the multiple band antenna device will be described using two antenna patterns as example.

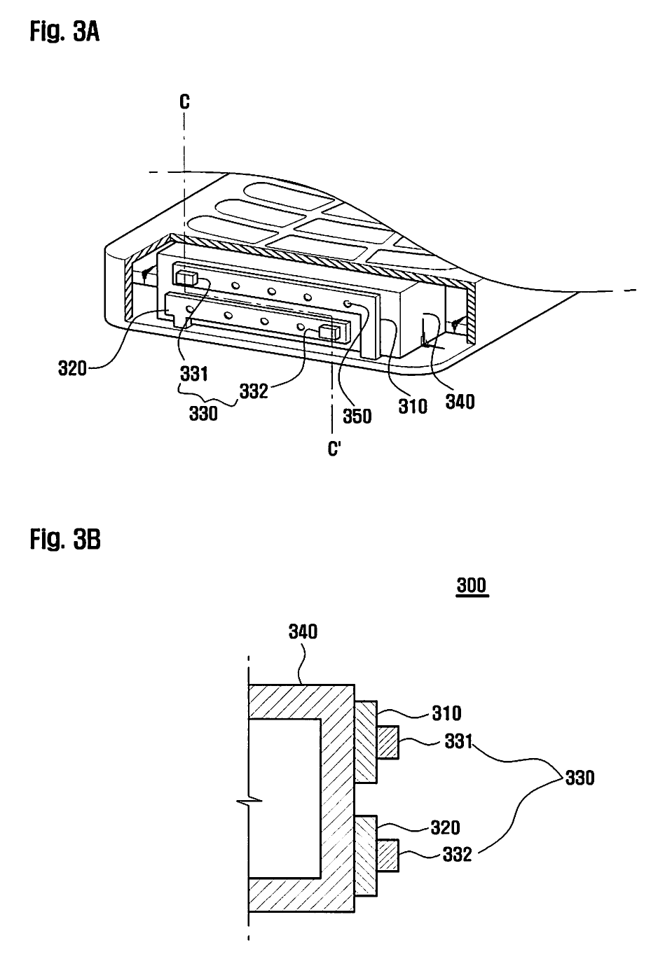

FIG. 3A is a perspective view of a multiple band antenna device according to another embodiment of the present invention, and FIG. 3B is a sectional view of the antenna device taken along line C-C′ of FIG. 3A.

Referring to FIGS. 3A and 3B, a multiple band antenna device 300 includes an antenna pattern unit, a magnetic body 330, and a carrier 340 for mounting the antenna pattern unit. The antenna pattern unit includes a first antenna pattern 310 having a first resonance frequency, a second antenna pattern 320 having a third resonance frequency, and a feeding unit (not shown).

The carrier 340 is formed in a rectangular form on which the antenna pattern unit is mounted at one side surface thereof, and is mounted within a mobile terminal. In order to fix the antenna pattern unit, the carrier 340 includes one or more protrusions 350 at one side surface thereof. The carrier 340 further includes a device for fixing the carrier 340 within the mobile terminal. A form of the carrier 340 and a location of the carrier 340 mounted in the mobile terminal are not limited to those described in the present embodiment, and the carrier 340 can have various forms according to a form of the mobile terminal. Further, the carrier 340 may be mounted at an upper part or a side surface of the mobile terminal according to a designer's intention.

The antenna pattern unit includes the first antenna pattern 310 and the second antenna pattern 320 individually formed on a frequency band basis and the feeding unit. Further, the first antenna pattern 310 and the second antenna pattern 320 each have a hole into which a protrusion 350 formed in the carrier 340 is forcibly fitted. The first antenna pattern 310 has a first resonance frequency, and the second antenna pattern 320 has a third resonance frequency. A form and attached location of the antenna pattern unit are not limited to those shown in FIGS. 3A and 3B.

As the magnetic body 330 is disposed adjacent to or contacting with one side of at least one of the first antenna pattern 310 and the second antenna pattern 320, a resonance frequency of the corresponding first antenna pattern 310 or second antenna pattern 320 can be shifted. The magnetic body 330 includes a first magnetic body 331 disposed adjacent to or contacting with the first antenna pattern 310 and a second magnetic body 332 disposed adjacent to or contacting with the second antenna pattern 320. As the first magnetic body 331 is disposed adjacent to or contacting with the first antenna pattern 310, the first resonance frequency is shifted to a second resonance frequency, and as the second magnetic body 332 is disposed adjacent to or contacting with the second antenna pattern 320, a third resonance frequency is shifted to a fourth resonance frequency. In this case, the first magnetic body 331 and the second magnetic body 332 contact with or are disposed adjacent to a location having the highest current density in the antenna pattern unit, for example, at an end portion of the first antenna pattern 310 and the second antenna pattern 320, respectively. For example, the magnetic body 330 may be attached to the antenna pattern unit using an adhesive tape.

Further, the magnetic bodies 331 and 332 are mounted at one side of a case of the mobile terminal, and when assembling the mobile terminal, the magnetic bodies 331 and 332 are disposed adjacent to or in contact with the first antenna pattern 310 and the second antenna pattern 320, respectively. For this, the mobile terminal case includes at least one groove (not shown) for mounting the magnetic body 330. Preferably, the groove is formed at a location corresponding to an end portion of the first antenna pattern 310 and of the second antenna pattern 320 having the highest current density. However, a form of the magnetic body 330 is not limited to those shown in FIGS. 3A and 3B, and the form and magnetic permeability of the magnetic body 330 can be changed according to a designer's intention and an experimentation result. For example, when manufacturing the magnetic body 330 to have magnetic permeability corresponding to a shift degree of a resonance frequency of the antenna pattern, the designer can variably adjust a manufacturing environment such as a temperature and a pressure and can change a form and a size of the magnetic body 330 according to a design of the mobile terminal and the carrier 340.

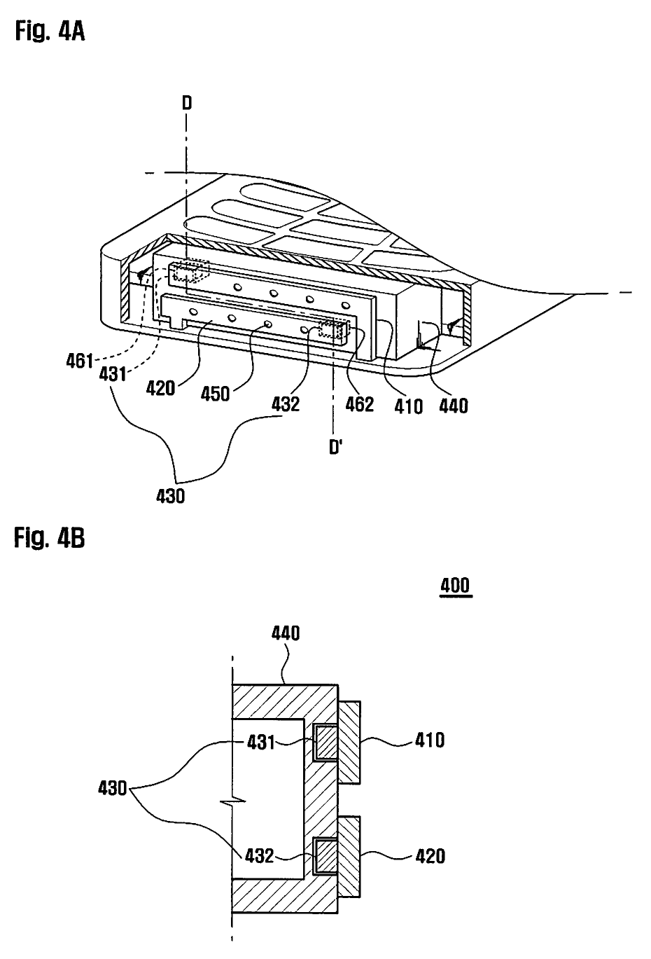

FIG. 4A is a perspective view of a multiple band antenna device according to another embodiment of the present invention, and FIG. 4B is a sectional view of the antenna device taken along line D-D′ of FIG. 4A.

Referring to FIGS. 4A and 4B, a multiple band antenna device 400 includes an antenna pattern unit, a magnetic body 430, and a carrier 440 for mounting the antenna pattern unit. The antenna pattern unit includes a first antenna pattern 410, a second antenna pattern 420, and a feeding unit (not shown).

The carrier 440 is formed in a rectangular form on which the antenna pattern unit is mounted at one side surface thereof, and is mounted within a mobile terminal. The carrier 440 has one or more protrusions 450 for fixing the antenna pattern unit at one side surface thereof. The carrier 440 further includes a device for fixing the carrier 440 within the mobile terminal. Particularly, the carrier 440 includes a first groove 461 and a second groove 462 for mounting the magnetic body 430 at a location at which the first antenna pattern 410 and the second antenna pattern 420, respectively, are attached to the carrier 440. Preferably, the grooves 461 and 462 are formed at a location corresponding to an end portion of the first antenna pattern 410 and the second antenna pattern 420, respectively, having high current density, as shown in FIG. 4A. Further, it is preferable that the grooves 461 and 462 are formed at a depth such that the magnetic body 430 protrudes from a surface of the carrier 440 rather than being recessed below the surface of the carrier 440. While the grooves 461 and 462 may be formed as holes according to a form of the carrier 440, the form and a mounting location of the carrier 440 are not limited to those illustrated in FIGS. 4A and 4B. That is, the carrier 440 can have various forms according to a form of the mobile terminal, and can be mounted at an upper part or a side surface of the mobile terminal according to a designer's intention.

The magnetic body 430 shifts a resonance frequency of the antenna pattern unit. The magnetic body 430 includes a first magnetic body 431 disposed adjacent to or contacting with the first antenna pattern 410 and a second magnetic body 432 disposed adjacent to or contacting with the second antenna pattern 420. The first magnetic body 431 and the second magnetic body 432 have a rectangular form and have a size smaller than the width of the first antenna pattern 410 and second antenna pattern 420, respectively. The first magnetic body 431 is inserted into the first groove 461 formed in the carrier 440, and the second magnetic body 432 is inserted into the second groove 462. Preferably, the first magnetic body 431 and the second magnetic body 432 have a height greater than the depth of the grooves 461 and 462, respectively, so as to easily contact with the first antenna pattern 410 and the second antenna pattern 420.

As the first magnetic body 431 is disposed adjacent to or in contact with the first antenna pattern 410, the first resonance frequency is shifted to a second resonance frequency, and as the second magnetic body 432 is disposed adjacent to or in contact with the second antenna pattern 420, a third resonance frequency is shifted to a fourth resonance frequency. A form of the magnetic body 430 of the present exemplary embodiment is not limited to that illustrated in FIGS. 4A and 4B.

The antenna pattern unit includes the first antenna pattern 410 having the first resonance frequency, the second antenna pattern 420 having the third resonance frequency, and the feeding unit (not shown) for electrically connecting the first antenna pattern 410 and the second antenna pattern 420 to the PCB. The first antenna pattern 410 and the second antenna pattern 420 are attached to the carrier 440, and a side of the first antenna pattern 410 and of the second antenna pattern 420 contact with the magnetic bodies 431 and 432, respectively, mounted in the grooves 461 and 462. A form and an attached location of the antenna pattern unit are not limited to those illustrated in FIGS. 4A and 4B.

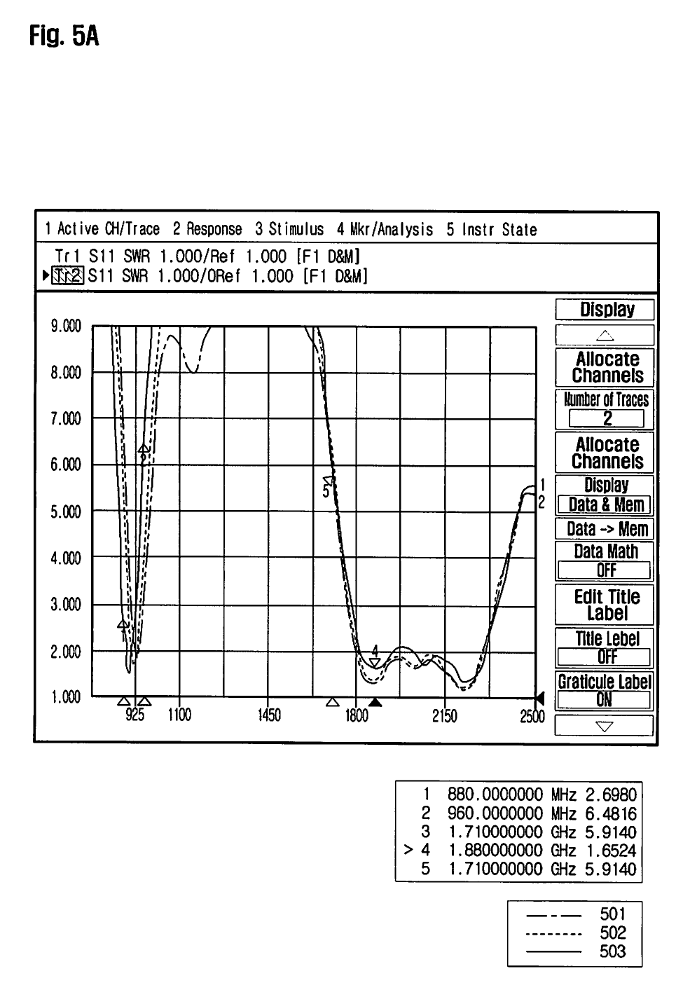

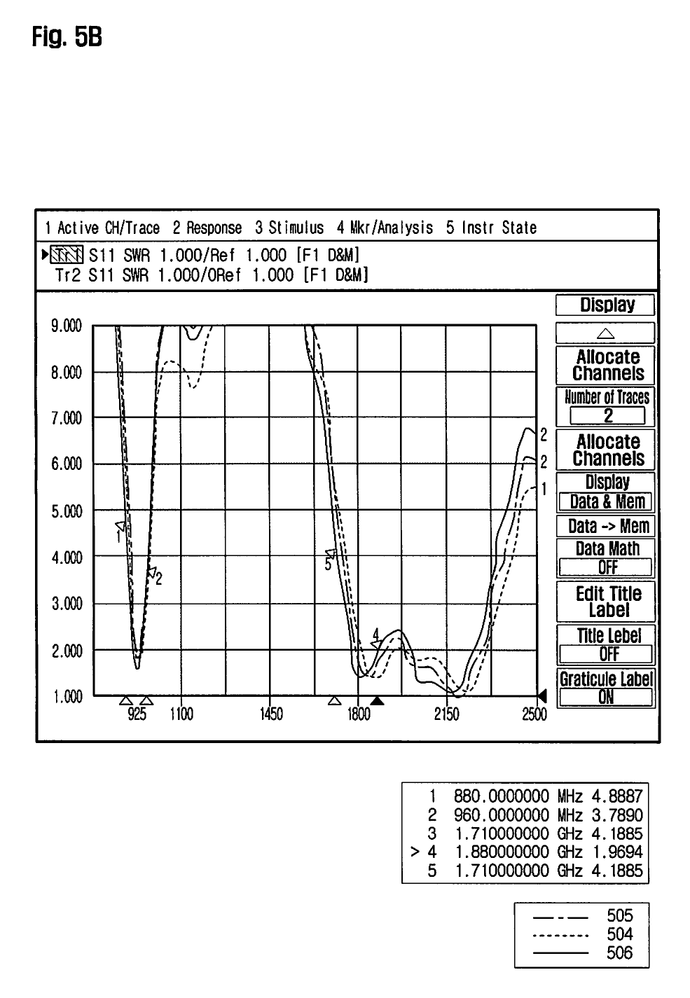

FIGS. 5A and 5B are graphs illustrating a shift of a resonance frequency of the antenna device 300 of FIG. 3A.

Referring to FIG. 5A, a first graph 501 is a resonance frequency graph when no material is attached to the first antenna pattern 310 and the second antenna pattern 320, a second graph 502 is a resonance frequency graph when PolyCarbonate (PC) is attached at an end portion of the first antenna pattern 310, and a third graph 503 is a resonance frequency graph when ferrite is attached at the same location as that of the PC.

When comparing the first to third graphs, it can be seen that the resonance frequency of the first antenna pattern 310 is shifted to a low frequency. Particularly, it can be seen that the difference between the first resonance frequency and the second resonance frequency is great when ferrite having high magnetic permeability is attached. Further, it can be seen that ferrite attached to the first antenna pattern 310 has no influence on a resonance frequency of the second antenna pattern 320. That is, the antenna device according to the present embodiment can selectively shift a resonance frequency when a plurality of antenna patterns exist.

Referring to FIG. 5B, a fourth graph 504 is a resonance frequency graph when no material is attached to the first antenna pattern 310 and the second antenna pattern 320, a fifth graph 505 is a resonance frequency graph when PC is attached at an end portion of the second antenna pattern 320, and a sixth graph 506 is a resonance frequency graph when ferrite is attached at the same location as that of the PC.

When comparing the fourth to sixth graphs, as described above, when ferrite having great magnetic permeability is attached, it can be seen that the difference between the third resonance frequency and the fourth resonance frequency of the second antenna pattern 320 is great. In this case, it can be seen that ferrite attached to the second antenna pattern 320 has no influence on a resonance frequency of the first antenna pattern 310. That is, it can be seen that the ferrite shifts only a resonance frequency of the contacted antenna pattern.

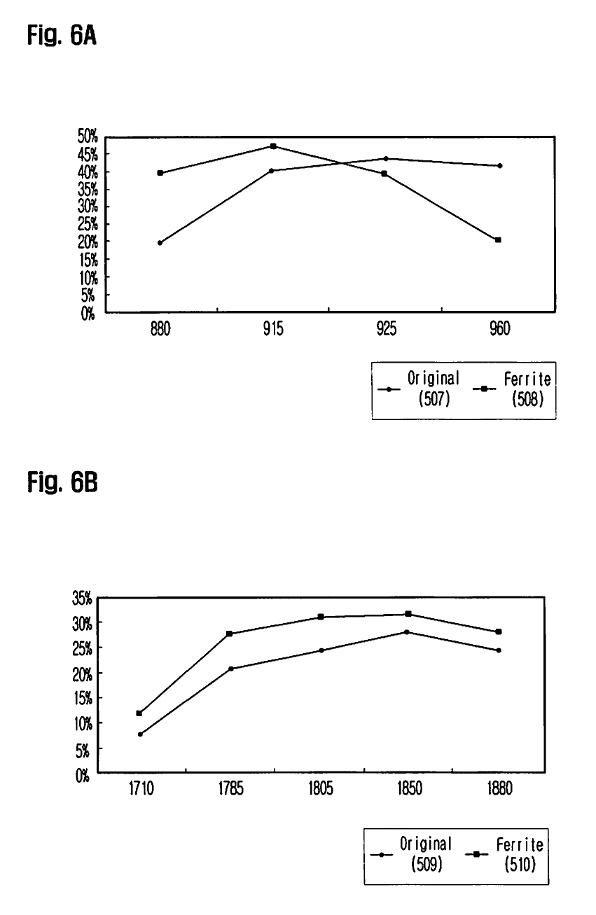

FIGS. 6A and 6B are graphs illustrating radiation efficiency of the antenna device 300 of FIG. 3A. More specifically, in FIGS. 6A and 6B, for convenience of description, radiation efficiency graphs when ferrite is attached are compared with those when ferrite is not attached.

FIG. 6A is a graph illustrating radiation efficiency of the first antenna pattern 310, and FIG. 6B is a graph illustrating radiation efficiency of the second antenna pattern 320.

Referring to FIG. 6A, when comparing a radiation efficiency graph of the first antenna pattern 310, when ferrite is not attached (hereinafter, a seventh graph 507), and a radiation efficiency graph of the first antenna pattern 310, when ferrite is attached (hereinafter, an eighth graph 508), radiation efficiency of the seventh graph 507 is greatest at 925 to 960 MHZ and radiation efficiency of the eighth graph 508 is greatest at 880 to 915 MHz. That is, radiation efficiency is improved according to a resonance frequency shifted due to ferrite attached to the first antenna pattern 310. Accordingly, even if a resonance frequency is shifted by ferrite, radiation efficiency of the first antenna pattern 310 is not reduced.

Referring to FIG. 6B, even if ferrite is attached, radiation efficiency of the second antenna pattern 320 is not reduced, as with the graphs shown in FIG. 6A. Specifically, the greatest radiation efficiency is obtained at 1850 to 1880 MHz in a radiation efficiency graph when ferrite is not attached (i.e., a ninth graph 509), and the greatest radiation efficiency is obtained at 1805 to 1850 MHz in a radiation efficiency graph when ferrite is attached (i.e., a tenth graph 510).

As described above, because an antenna device for shifting a resonance frequency according to the present invention can shift a resonance frequency of an antenna to correspond to a plurality of mobile communication services without redesigning an individual antenna according to a frequency band of a mobile communication service, a cost for developing and manufacturing the antenna can be reduced. Further, even when a resonance frequency is shifted, radiation efficiency of the antenna is not reduced. Further, the difference between the first resonance frequency and the second resonance frequency can be changed according to an attached location of a magnetic body attached to an antenna pattern. Consequently, rather than design a new antenna, a designer can adjust a shift degree of a resonance frequency by adjusting an attached location of a magnetic body.

In the foregoing description, embodiments of antenna devices having one antenna pattern and two antenna patterns are described, however the present invention is not limited thereto. For example, the present invention can be applied to a multiple band antenna device having three or more antenna patterns.

Further, in the foregoing description, the magnetic body directly contacts with the antenna pattern, however the present invention is not limited thereto. That is, the magnetic body can be mounted at a location (for example, within several mm) adjacent to the antenna pattern.

As described above, according to the present invention, even when a first resonance frequency of the antenna pattern is shifted to a second resonance frequency, radiation efficiency is not reduced.

Although embodiments of the present invention have been described in detail hereinabove, it should be clearly understood that many variations and modifications of the basic inventive concepts herein described, which may appear to those skilled in the art, will still fall within the spirit and scope of the embodiments of the present invention as defined in the appended claims.

What is claimed is:

1. An antenna device for shifting a resonance frequency, comprising:
an antenna pattern having a first resonance frequency; and
a magnetic body disposed within a predetermined distance of or contacting with one side of the antenna pattern for shifting the first resonance frequency to a second resonance frequency.

2. The antenna device of claim 1, wherein the magnetic body is disposed within the predetermined distance of or contacting with a portion of the antenna pattern having a highest current density when transmitting and receiving a signal.

3. The antenna device of claim 1, wherein the magnetic body comprises ferrite.

4. The antenna device of claim 1, further comprising a double-sided adhesive tape for fixing the magnetic body to the antenna pattern.

5. The antenna device of claim 1, wherein the magnetic body is mounted at one side of a case of a mobile terminal so as to be disposed within the predetermined distance of or contacting with the antenna pattern when the mobile terminal is assembled.

6. The antenna device of claim 5, wherein the mobile terminal case comprises a groove for inserting the magnetic body.

7. The antenna device of claim 1, further comprising a carrier for mounting the antenna pattern.

8. The antenna device of claim 7, wherein the carrier comprises at least one of:
a groove; and
a hole for receiving the magnetic body.

9. The antenna device of claim 8, wherein the at least one of the groove and the hole is formed at a location corresponding to a portion of the antenna pattern having a highest current density.

10. The antenna device of claim 8, wherein the groove is formed at a depth that enables the magnetic body to protrude from the groove when the magnetic body is inserted therein.
